(19) United States
(12) Patent Application Publication
(10) Pub. No.: US 2014/0314317 A1
(43) Pub. Date: Oct. 23, 2014

(54) METHOD AND APPARATUS FOR CONVERTING GRAY LEVEL OF COLOR IMAGE

(71) Applicant: SAMSUNG ELECTRONICS CO., LTD., Suwon-si (KR)

(72) Inventors: Byung-Seok MIN, Seoul (KR); Seong-wook HAN, Seoul (KR); Jong-Man KIM, Gunpo-si (KR); Hyung-jun PARK, Seongnam-si (KR)

(73) Assignee: SAMSUNG ELECTRONICS CO., LTD., Suwon-si (KR)

(21) Appl. No.: 14/255,095

(22) Filed: Apr. 17, 2014

(30) Foreign Application Priority Data
Apr. 18, 2013 (KR) 10-2013-0043034

(51) Int. Cl. G06T 7/40

(52) U.S. Cl. CPC G06T 7/408
USPC 382/167

(57) ABSTRACT

A method and apparatus for converting a gray level of a color image are provided. The method of converting the gray level includes determining an intermediate RGB value which corresponds to an input RGB value of the color image, based on color mapping information in which target RGB values, mapped to the gray levels of the color image, are preset; determining whether the input RGB value is included in a gray region or a color region, based on a gray variation of the input RGB value; and, if the input RGB value is determined to be included in the gray region, converting the input RGB value by using the intermediate RGB value.

### CROSS-REFERENCE TO RELATED PATENT APPLICATION(S)

This application claims the benefit of Korean Patent Application No. 10-2013-0043034, filed on Apr. 18, 2013, in the Korean Intellectual Property Office, the disclosure of which is incorporated herein in its entirety by reference in its entirety.

### BACKGROUND

1. Field

Apparatuses and methods consistent with exemplary embodiments relate to providing a method and apparatus for converting color of a color image, and more particularly, to providing a method and apparatus for converting color temperatures of a gray level of a color image.

2. Description of Related Art

When adjusting color temperatures of a gray level, not only components of a gray region, but also color components of a color region are changed. For example, when a bump appears on a gray level curve at X and Y color coordinates, some of a red (R)-component curve, a green (G)-component curve, and a blue (B)-component curve of the gray level curve may be adjusted so as to modify the undesired bump. However, a color composition of the original color level may be also changed by this adjustment.

As the color temperatures of the gray level change, values of the R-component curve, G-component curve, and B-component curve, which form the gray level, also change. Therefore, according to the changing direction of the color temperatures, a saturation level of a particular color region may be reduced and may cause deterioration in picture quality for a viewer.

### SUMMARY

Exemplary embodiments address at least the above problems and/or disadvantages and other disadvantages not described above. Also, the exemplary embodiments are not required to overcome the disadvantages described above, and exemplary embodiments may not overcome any of the problems described above.

One or more exemplary embodiments provides a method of adjusting a color temperature of a gray level, and more particularly, a method of distinguishing a gray region and color region and converting the color temperature of the gray level.

According to an aspect of an exemplary embodiment, there is provided a method of converting a gray level of a color image, the method including determining an intermediate RGB value which corresponds to an input RGB value of the color image, based on color mapping information in which target RGB values, mapped to the gray levels of the color image, are preset; determining whether the input RGB value is included in a gray region or a color region, based on a gray variation of the input RGB value; and if the input RGB value is determined to be included in the gray region, converting the input RGB value by using the intermediate RGB value.

The converting of the input RGB value determined to be included in the gray region by using the intermediate RGB value includes outputting the determined intermediate RGB value for a first input RGB value determined to be included in the gray region.

The converting of the input RGB value determined to be included in the gray region by using the intermediate RGB value includes outputting an arbitrary RGB value which is different from the intermediate RGB value, for a first input RGB value determined to be included in the gray region.

The determining of the intermediate RGB value which corresponds to the input RGB value of the color image includes determining an input gray level which corresponds to the input RGB value, and determining the intermediate RGB value that is mapped to the input gray level, by using a look-up table in which target RGB values, mapped to the gray levels of the color image, are preset.

According to an aspect of another exemplary embodiment, there is provided an apparatus for converting a gray level including a gray region determiner for determining an intermediate RGB value which corresponds to an input RGB value of the color image, based on color mapping information including preset target RGB values that are mapped to the gray levels of the color image, and determining whether the input RGB value is included in a gray region or a color region, based on a gray variation of the input RGB value; and a converter for converting, if the input RGB value is determined to be included in the gray region, the input RGB value by using the intermediate RGB value, and determining an output RGB value of the input RGB value.

The converter outputs the determined intermediate RGB value for a first input RGB value determined to be included in the gray region.

According to an aspect of another exemplary embodiment, there is provided a non-transitory computer readable recording medium having recorded thereon a program, which when executed by a computer, performs the method of one or more exemplary embodiments.

According to an aspect of another exemplary embodiment, there is provided a method of adjusting a grey level of a color image including determining an intermediate RGB value which corresponds to an input RGB value of the color image, determining if the input RGB value is distributed in a grey region or in a color region of the color image, if it is determined that the input RGB value is distributed in the grey region, converting the input RGB value using the intermediate value and outputting the converted input RGB value; and if it is determined that the input RGB value is distributed in the color region, outputting the input RGB value.

### BRIEF DESCRIPTION OF THE DRAWINGS

The above and other features and advantages will become more apparent by describing certain exemplary embodiments with reference to the attached drawings in which:

FIG. 1A is a block diagram of an apparatus for converting a gray level, according to an exemplary embodiment;

FIG. 1B is a flowchart of a method of converting a gray level, according to an exemplary embodiment;

FIG. 2 is a flowchart of specific operations of the apparatus for converting a gray level, according to an exemplary embodiment;

FIG. 3 illustrates color temperature changes according to a gray level;

FIG. 4 illustrates RGB gamma curves generated by adjusting color variation; and

FIG. 5 illustrates RGB gamma curves generated by changing a color temperature of a gray level.

### DETAILED DESCRIPTION OF THE EXEMPLARY EMBODIMENTS

Hereinafter, certain exemplary embodiments will be described more fully with reference to the accompanying drawings. The matters defined in the following description, such as detailed construction and elements, are provided to assist in a comprehensive understanding of the exemplary embodiments. However, the exemplary embodiments can be practiced without those specifically defined matters. Also, well-known functions or constructions are not described in detail since they would obscure the exemplary embodiments with unnecessary detail.

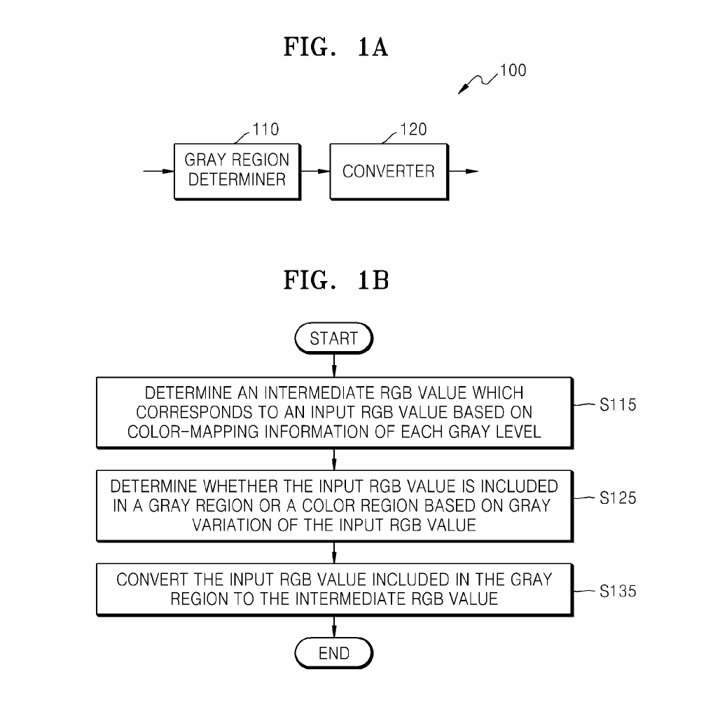

FIG. 1A is a block diagram of an apparatus 100 for converting a gray level, according to an exemplary embodiment.

The apparatus 100 includes a gray region determiner 110, and a converter 120. The apparatus 100 for converting a gray level receives a color image, analyzes pixel values of the color image and determines a gray region of the color image, and generates an image having a converted gray level only in the gray region.

The gray level of the color image may be also referred to as a gray tone.

The apparatus 100 uses RGB values of color pixel values to convert the gray level of the color image. Hereinafter, an RGB value of a color pixel value is a generic term for an R-component value, a G-component value, and a B-component value of the color pixel value. The apparatus 100 may use the RGB values of color pixel values to perform various operations. Unless an exception is described, when an operation is performed using the RGB value of the color pixel value, separate operations including an operation using the R-component value, an operation using the G-component value, and an operation using the B-component value of the color pixel value are regarded as being performed.

According to the present exemplary embodiment, the gray region determiner 110 may determine an intermediate RGB value which corresponds to an input RGB value of the color image, based on color mapping information, in which target RGB values, mapped to the gray levels of the color image, are preset.

The gray region determiner 110 may also determine whether the input RGB value is included in the gray region or a color region, based on a gray variation of the input RGB value.

The converter 120 may convert the input RGB value, determined to be included in the gray region, by using the gray region determiner 110, and output the converted RGB value. The converter 120 may use the intermediate RGB value to convert the input RGB value of the gray region.

Therefore, the converter 120 may determine a final output RGB value, which corresponds to the input RGB value, based on the conversion results of the input RGB value.

The operations of the gray region determiner 110 and converter 120 will be described in greater detail with reference to FIG. 1B.

FIG. 1B is a flowchart of a method of converting a gray level, according to an exemplary embodiment.

In operation S115, the RGB values of the color pixels are input to the gray region determiner 110. The gray region determiner 110 may determine the intermediate RGB value which corresponds to the input RGB value, based on the color mapping information, in which the target RGB values are predetermined so as to be mapped to the gray levels of the color image.

First, the gray region determiner 110 may determine an input gray level which corresponds to the input RGB value. Using a look-up table, in which the target RGB values, mapped to the gray levels of the color image, are preset, a target RGB value to be mapped to the input gray level may be detected. The detected target value may be determined as the intermediate RGB value which corresponds to the input RGB value.

In detail, the gray region determiner 110 may detect a first gray level and a second gray level that neighbor the input gray level among the gray levels of the look-up table. The gray region determiner 110 may determine a first target RGB value which corresponds to the first gray level, and a second target RGB value which corresponds to the second gray level. The gray region determiner 110 may interpolate the detected first and second target RGB values, and use the interpolated values to determine the intermediate RGB value which corresponds to the input RGB value. Since the intermediate RGB value is determined based on the look-up table which includes the target RGB values, the determined intermediate RGB value may be added to the look-up table as a target RGB value.

Accordingly to the present exemplary embodiment, in operation S125, the gray region determiner 110 may determine whether the input RGB value is included in the gray region or the color region, based on the gray variation of the input RGB value. The gray variation may represent a distance between a predetermined RGB value and a gray axis.

According to an exemplary embodiment, in order to determine the gray variation of the input RGB value, the gray region determiner 110 may determine a YCrCb value which corresponds to the input RGB value. The gray region determiner 110 may use the YCrCb value of the input RGB value to determine a saturation level of the input RGB value. The gray variation of the input RGB value is determined using the saturation level of the input RGB value.

According to another exemplary embodiment, among the input RGB values, the gray region determiner 110 may determine an R-G difference value between an R-value and a G-value, an R-B difference value between the R-value and a B-value, and a G-B difference value between the G-value and the B-value. The R-G difference value, R-B difference value, and G-B difference value of the input RGB value may be used to determine the gray variation of the input RGB value.

The method of determining the gray variation of the input RGB value is not limited to the exemplary embodiments described above. Based on the gray variation of the input RGB value that is determined according to various exemplary embodiments, the gray region determiner 110 may determine whether the input RGB value is included in the gray region or the color region.

According to the present exemplary embodiment, in operation S135, the converter 120 may determine an output RGB value which corresponds to the input RGB value. The method of determining the output RGB value may vary depending on whether the input RGB value is determined to be included in the gray region or the color region by the gray region determiner 110.

According to the present exemplary embodiment, when the gray region determiner 110 determines that the input RGB value is included in the gray region, the converter 120 may determine the intermediate RGB value, determined in the gray region determiner 110, as the output RGB value which corresponds to the input RGB value. That is, the converter 120 may output the target RGB value which is determined based on the look-up table.

According to the present exemplary embodiment, when the gray region determiner 110 determines that the input RGB value is included in the color region, the converter 120 may maintain the input RGB value as the output RGB value which corresponds to the input RGB value. That is, the converter 120 may not convert the input RGB value included in the color region, but may directly output the input RGB value.

According to another exemplary embodiment, when the gray region determiner 110 determines that the input RGB value is included in the color region, the converter 120 may adjust the intermediate RGB value to be inversely proportional to the gray variation, add the adjusted intermediate RGB value and the input RGB value, and thus determine the output value which corresponds to the input RGB value.

According to another exemplary embodiment, when the gray region determiner 110 determines the input RGB value is included in the gray region, the converter 120 may output an arbitrary RGB value which is different from the intermediate RGB value, as the input RGB value.

Referring back to operation S115, if the input RGB value is reverse gamma-corrected, the converted input RGB value may additionally be gamma-corrected in operation S135.

A color temperature is a numerical value of a light source. Thus, the color temperature may be determined in the pixel values of a color image. The color temperature of the gray level is generally proportional to the degree of light intensity. Since the degree of light intensity is determined according to the RGB components of the color pixels, changing the RGB value may cause the color temperature to change. Thus, the RGB value may be changed so as to change the color temperature.

However, since the color temperature of each RGB component is different, even for a fixed gray level, if a ratio of the RGB components composing the gray level changes, the color temperature of the gray level may also change. Since a change of the color temperature may cause the color temperature of the gray level in an image not to be uniform, picture quality may be deteriorated.

Thus, according to the present exemplary embodiment, the apparatus 100 may determine the gray region in the color image, and convert the input RGB value only in the gray region such that the color temperatures of each gray level may be identical. Therefore, the color temperature adjustment, which is accompanied by the conversion of the input RGB value, may be limited only to the gray region. Thus, low-picture quality due to the non-uniform color temperature of the gray level may be prevented.

Therefore, according the present exemplary embodiment, the apparatus 100 may maintain a highly saturated color distributed in the color region in the color image, and only adjust the color temperature of the gray level distributed in the gray region. Thus, a white balance process may be more effective.

According to another exemplary embodiment, since only the input RGB value of the gray region may be adjusted, only the color temperature of the gray level of the gray region may be converted to a user-defined arbitrary temperature, but colors in a color region other than the gray region may be maintained. Therefore, the highly saturated colors may be maintained, and only the gray level colors may be converted in various ways.

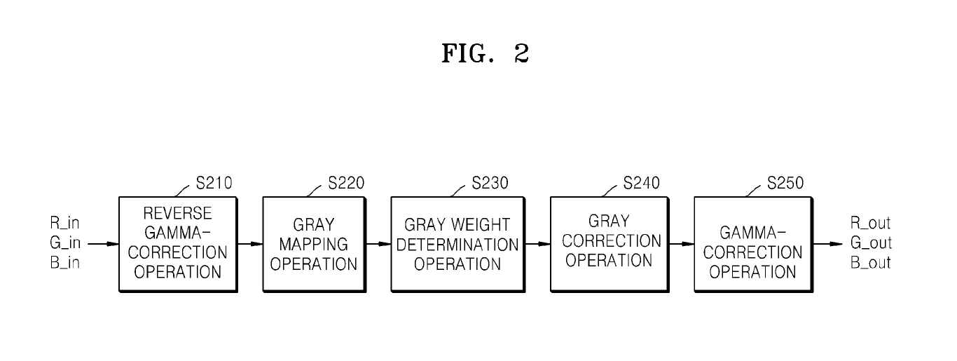

Hereinafter, operations of the apparatus 100, according to the exemplary embodiment, will be described based on mathematical principles with reference to FIG. 2.

FIG. 2 is a flowchart of specific operations of the apparatus 100 for converting the gray level, according to an exemplary embodiment.

According to the present exemplary embodiment, the operations of the apparatus 100 may include a reverse gamma-correction operation S210, a gray mapping operation S220, a gray weight determination operation S230, a gray correction operation S240, and a gamma-correction operation S250.

The gray region determiner 110 may perform operations S210, S220, and S230. The converter 120 may perform operations S240 and S250.

In operation S210, the input RGB values (R_in, G_in, B_in) are input. In step S250, the output RGB values (R_out, G_out, B_out) are output. Operations S210, S220, S230, S240, and S250 may be performed with respect to each color component.

Optical devices, such as cameras for general use or broadcasting use, may receive analog or digital image signals. The initial image signals received by the optical devices may be processed according to features of display apparatuses, and then transmitted to the display apparatuses such as televisions, monitors, or mobile displays in a form of broadcasting images or photographs.

For example, although the initial image signals received in the optical devices are signals that vary depending on features of image sensors provided in the optical devices, the initial image signals may be gamma corrected according to color standards. Then, the gamma corrected image data may be transmitted to the display apparatus. It is assumed that the image signals are output using a display apparatus with a display gamma of about 2.2. Accordingly, the display apparatus may perform gamma-correction on the initial image signals, reflecting the display gamma of about 2.2, and store the gamma corrected data in a recording medium or files. In order to be displayed on cathode ray tube (CRT) displays, the gamma-corrected image data may be further adjusted to comply with color standards such as BT. 601, BT. 709, or sRGB.

The color information of a certain color using the optical devices may be expressed using XYZ color space values. The XYZ values measured using the optical devices are proportional to linear RGB values that are not yet gamma corrected.

According to the present exemplary embodiment, the apparatus 100 may use the linear RGB values to adjust the gray levels of the color image. The gray levels to be adjusted may not be sequentially distributed, but may be distributed according to a predetermined distance. For example, among the gray levels having values from 0 to 255, the gray levels having values that are distributed according to a predetermined distance such as [0, 32, 64, 96, . . . ] may be adjusted. The RGB value, which corresponds to the gray level between the predetermined gray levels to be adjusted, may be estimated based on the linear relationship between the RGB values. Therefore, when the apparatus 100 has already received the gamma corrected input RGB value, reverse gamma-correction may be performed to convert the received input RGB value into the linear RGB value.

In operation S210, the image signals may be converted into the linear RGB value by performing reverse gamma-correction. Then, the gray level of the linear RGB value may be converted by performing operations S220, S230, and S240. Before being finally output, the linear RGB value may be converted into data format appropriate for display apparatuses, by performing gamma adjustment in operation S250.

According to Equations 1 and 2 below, the linear RGB values that are not yet gamma adjusted may be converted into signals to be output to the display apparatuses which respectively use an sRGB color format and a 709 RGB color format.

Equation 1 is used to convert the linear RGB values into the sRGB color format. In Equation 1, C_{srgb} is an sRGB value of the input image and a normalized value into a scale between 0 and 1 from an original scale between 0 and 255. Based on the color components, R_{srgb} refers to R-components, G_{srgb} refers to G-components, B_{srgb} refers to B-components. Cₗᵢₙₑₐᵣ is a reverse gamma-corrected RGB value, and Rₗᵢₙₑₐᵣ refers to R-components of the input image, Gₗᵢₙₑₐᵣ refers to G-components of the input image, Bₗᵢₙₑₐᵣ refers to B-components of the input image.

$${C}_{srgb} = \{ \begin{matrix}12.92 {C}_{linear} , & {C}_{liner} \leq 0.0031308 \\ ( 1 + a ) {C}_{linear}^{1 / 2.4} - α , & {C}_{liner} > 0.0031308\end{matrix} \\ where a = 0.055 \qquad [ Equation 1 ]$$

In the case of a TV broadcasting image, gamma-correction and reverse gamma-correction may be performed based on the BT. 709 color format. In Equation 2 below, C_{709 RGB} is an RGB value of input image which is normalized into a scale between 0 and 1.

C_{709 RGB}=1.099Cₗᵢₙₑₐᵣ^{0.45}−0.099, for 1≧Cₗᵢₙₑₐᵣ≧0.018

C_{709 RGB}=4500Cₗᵢₙₑₐᵣ, for 0.018>Cₗᵢₙₑₐᵣ≧0 [Equation 2]

The operations S210 and S250 are counter operations relative to each other. That is, in operation S250, the linear RGB value (Cₗᵢₙₑₐᵣ) is converted into a value (C_{srgb} or C_{709 RGB}) complying with color standards according to Equations 1 or 2, and then, the converted value is output. In operation S210, the values converted to fit color standards (C_{srgb} or C_{709 RGB}), according to the counter operations of Equations 1 or 2, may be converted back to the linear RGB value (Cₗᵢₙₑₐᵣ).

In operation S220, by using the look-up table, the input RGB values may be respectively mapped to the corresponding target RGB values.

According to the present exemplary embodiment, the apparatus 100 may use the look-up table which includes information of target RGB values that correspond to each gray level. By using the apparatus 100 to map the input RGB value to the target RGB value that is set by a user, the corresponding target RGB value may be detected using the gray level of the input RGB value. Therefore, without contours, the mapping effect may be applied even to RGB values that are not gray components.

According to Equation 3 below, the gray level of the input RGB value may be determined. Arbitrary input RGB values (Rₛ₁, Gₛ₁, Bₛ₁) may be converted into corresponding gray level values (Kₛ, Kₛ, Kₛ). w₁, w₂, w₃ respectively refer to weights of the R-components, G-components, and B-components. According to Equation 3, in order for the gray level Kₛ to represent the luminance value of the input RGB value, a relationship of w₁≦w₂≦w₃ may be set. In the YCbCr color format according to the BT. 709 color standard, the relationship of (w₁, w₂, w₃)=(0.299, 0.587, 0.114) may be set.

$${K}_{s} = \frac{{w}_{1} {R}_{S 1} + {w}_{2} {G}_{S 1} + {W}_{3} {B}_{s 1}}{{w}_{1} {w}_{2} {w}_{3}} \qquad [ Equation 3 ]$$

According to the present exemplary embodiment, the apparatus 100 may use the look-up table to determine the target RGB value which corresponds to the gray level of the input RGB value.

According to the present exemplary embodiment, the look-up table includes information regarding the gray levels to be adjusted and the target RGB values to be mapped to each gray level. Using the look-up table, the information regarding the gray level set by the user and the target RGB values to be mapped to each gray level, may be provided. Therefore, the gray level and target RGB value, selected based on the look-up table, may be a user-defined gray level and a user-defined RGB value.

The look-up table may only provide the target RGB values that are mapped to a limited number of gray levels. As the number of preset gray levels in the look-up table increases, the targeting accuracy of the gray level adjustment may be increased. As the targeting accuracy of the gray level adjustment increases, the number of preset adjustment targets in the look-up table increases, and the size of the look-up table increases. As the size of the look-up table increases, the size of the hardware storing the look-up table increases, and thus, there is an increase in costs. However, color variation, which varies irregularly depending on the gray level, may be adjusted more accurately.

According to the present exemplary embodiment, the apparatus 100 may generate the target RGB value, mapped to the gray level of the input RGB value which is not defined in the look-up table, by interpolating the RGB values provided in the look-up table.

For example, suppose the gray level of the input RGB value is not defined in the look-up table, but the gray level of the input RGB value exists between the first gray level and the second gray level defined in the look-up table. The target RGB values of the first and second gray levels may be interpolated and thus, the target RGB value which corresponds to the gray level of the input RGB value may be estimated using the interpolated value.

According to Equation 4 below, the input gray level Kₛ, which is the gray level of the input RGB value, is not defined in the look-up table. However, by using the gray levels that are defined in the look-up table and that are adjacent to the input gray level Kₛ and are the same or smaller than Kₛ (Kₛ₁), or, the same or larger than Kₛ (Kₛ₂), the target RGB value which corresponds to the input gray level Ks may be determined.

Since the RGB components of a gray component are identical to each other, the (R, G, B) component of gray levels Kₛ₁ and Kₛ₂ are respectively, (Kₛ₁, Kₛ₁, Kₛ₁) and (Kₛ₂, Kₛ₂, Kₛ₂). According to the look-up table, the gray level Kₛ₁ may be mapped to a target RGB value (R_{T1}, G_{T1}, B_{T1}), and the gray level Kₛ₂ may be mapped to a target RGB value (R_{T2}, G_{T2}, B_{T2}). A mapping result of the look-up table may be interpolated, and thus, the RGB-component (Kₛ, Kₛ, Kₛ) of the input gray level Kₛ may be mapped to (Rₒᵤₜ₁, Gₒᵤₜ₁, Bₒᵤₜ₁).

$$\begin{matrix}{R}_{out 1} = {R}_{T 1} + \frac{{R}_{T 2} - {R}_{T 1}}{{R}_{S 2} - {R}_{S 1}} ( {K}_{S} - {K}_{S 1} ) , & for {K}_{S 1} \leq {K}_{S} \leq {K}_{S 2} \\ {G}_{out 1} = {G}_{T 1} + \frac{{G}_{T 2} - {G}_{T 1}}{{G}_{S 2} - {G}_{S 1}} ( {K}_{S} - {K}_{S 1} ) , & for {K}_{S 1} \leq {K}_{S} \leq {K}_{S 2} \\ {B}_{out 1} = {B}_{T 1} + \frac{{B}_{T 2} - {B}_{T 1}}{{B}_{S 2} - {B}_{S 1}} ( {K}_{S} - {K}_{S 1} ) , & for {K}_{S 1} \leq {K}_{S} \leq {K}_{S 2}\end{matrix} \qquad [ Equation 4 ]$$

In operation S230, how close the input RGB value is to the gray axis of a color coordinate is, that is, the distance between the input RGB value and the gray axis, may be determined. According to the distance between the input RGB value and the gray axis, it may be determined whether the input RGB value is included in the gray region or the color region.

A gray weight may be determined to represent the distance between the input RGB value and the gray axis, or the value of gray variation of the input RGB value. Based on the gray weight of the input RGB value, the input RGB values included in the gray region and the color region may be distinguished.

The distance between the input RGB value and the gray axis may be expressed by a length of a perpendicular line extended from an input RGB value coordinate point in an RGB-CMWK cube graph to a line connecting black and white points. However, since a square root calculation needs to be performed in processes to find a perpendicular line and determine the length of the perpendicular line, a relatively large amount of hardware resources are necessary to implement a process of determining the distance between the input RGB value and the gray axis using the RGB-CMWK cube graph.

Therefore, one or more exemplary embodiments regarding estimation of the distance between the input RGB value and the gray axis according to the color format are described with reference to Equations 5 to 8 below.

First, a method of using the YCrCb color format will be described. According to the RGB-YCrCb converting equation of the Equation 5, C_{B} and C_{R} values, which are chroma components regarding the input RGB value, may be determined.

Y=0.299·R_{S}+0.587·G_{S}+0.114·B_{S}

C_{B}=128−0.168736·R_{S}−0.331264·G_{S}+0.5·B_{S}

C_{R}=128+0.5·R_{S}−0.418688·G_{S}−0.081312·B_{S} [Equation 5]

When the chroma components of the gray level (i.e., the C_{B} value and C_{R} value) are equal to 0 and are more relevant to original colors, values of the chroma components may increase. Using Equations 6 or 7, the gray weight, which represent the distance between the input RGB value and the gray axis, may be estimated using the C_{B} value and C_{R} value of the input RGB value. Here, w₁ and w₂ are weights that are adjustable by the user. Depending on w₁ and w₂, the color temperature may be adjusted and thus, the effect of the color region on the final output RGB value may increase or decrease.

weight=w₁·\sqrt{C_{B}²+C_{R}²}/Y+w₂ [Equation 6]

weight=w₁·(|C_{B}|+|C_{R}|)/Y+w₂ [Equation 7]

According to Equations 6 or 7, saturation of the color component may also be determined. Equation 7 uses less hardware resources than Equation 6 to determine the distance between the input RGB value and the gray axis. Thus, depending on hardware capacity, either of Equations 6 or 7 may be used to determine the weight.

According to another exemplary embodiment, the RGB color format may be used to determine the distance between the input RGB value and the gray axis. On the RGB graph, a coordinate farther away from a gray straight line having identical values of R-component, G-component, and B-component, has a larger difference between one component and the other components (that is, |R−(G+B)/2|, |G−(R+B)/2|, |B−(G+R)/2|). Even if the differences between two color components (|R−B|, |G−B|, |R−G|) are identical, the brighter color may seem to have visually less difference between the color components. Therefore, using the feature described above, the distance between the input RGB value and the gray axis may be determined according to Equation 8.

weight=(w₁·|R−(G+B)/2|+w₂·|G−(R+B)/2|+w₃·|B−(R+G)/2|)Y+w₄ [Equation 8]

According to another exemplary embodiment, the gray weight of the gray level having identical values of the R-component, G-component, and B-component of the input RGB value, is equal to 0. In addition, the gray weight of the input RGB value of an original color, which is far away from the gray axis, may be determined to be 1.

Therefore, according to the gray weight of the input RGB value, determined using Equations 6, 7 or 8, it may be determined whether the input RGB value is included in the gray region or the color region.

In operation S240, the color temperature of the input RGB value may be changed according to the distance between the input RGB value and the gray axis.

In operation S230, the proximity between the input RGB value and the gray axis is determined. Thus, the amount of the user-defined target RGB value that is to be applied on the final output RGB value may be determined.

In Equation 9 below, Rₒᵤₜ₂, Gₒᵤₜ₂, Bₒᵤₜ₂ represents the determined final output RGB value, and the gray weight represents the distance between the input RGB value and the gray axis, which is determined in operation S230.

Rₒᵤₜ₂=R_{S}+(Rₒᵤₜ₁−K_{S})(1−weight)

Gₒᵤₜ₂=G_{S}+(Gₒᵤₜ₁−K_{S})(1−weight)

Bₒᵤₜ₂=B_{S}+(Bₒᵤₜ₁−K_{S})(1−weight) [Equation 9]

According to Equation 9, the output RGB values Rₒᵤₜ₂, Gₒᵤₜ₂, Bₒᵤₜ₂ are determined by adding a value representing the distance between the user-defined RGB values Rₒᵤₜ₁, Gₒᵤₜ₁, Bₒᵤₜ₁, which are determined based on the look-up table, and the input gray level Kₛ, in which the value is adjusted to be negatively proportionate to the gray weight and the input RGB values (Rₛ, Gₛ, Bₛ).

Therefore, based on how the gray weight is determined, the amount of user-defined RGB value to be applied on the output RGB value may be determined.

For example, according to Equation 9, since the gray weight of the gray level equals 0 and the input RGB value is identical to the gray level value, the output RGB values Rₒᵤₜ₂, Gₒᵤₜ₂, Bₒᵤₜ₂ may be determined as the user-defined RGB values Rₒᵤₜ₁, Gₒᵤₜ₁, Bₒᵤₜ₁. Also, since the gray weight of the original color equals 1, the output RGB values Rₒᵤₜ₂, Gₒᵤₜ₂, Bₒᵤₜ₂ may be determined as the input RGB values Rₛ, Gₛ, Bₛ.

That is, depending on whether the input RGB value is included in the gray region or the color region, the proportion of the value of the user-defined gray level to be applied to the final output RGB value may be determined. According to the gray weight, only the input RGB value included in the gray region is converted into the target RGB value and output. The input RGB value in the color region is not converted and is directly output.

As another example, a summation proportion of the input RGB value and the target RGB value is adjusted according to the gray weight. Thus, the target RGB value and the input RGB value may be used to determine the final output RGB value. According to Equation 9, the output RGB values are determined by adding a value representing the distance between the user-defined RGB values and the input gray level Kₛ, which is adjusted to be negatively proportional to the gray weight and the input RGB values.

In a region having a relatively low gray weight, that is, a region adjacent to the gray region, a large user-defined RGB value is added to the input RGB value. Therefore, a value approximate to the user-defined RGB value may be output. In a region having a relatively high gray weight, that is, a region adjacent to the color region, a low target RGB value is added to the input RGB value. Thus, an approximate value of the input RGB value may be output.

As the RGB value, which is determined to be included in the gray region in the color format in operations S210 to S240 described above, is converted, the gray level color temperature may be converted to be uniform.

As described above, in a case where the linear RGB value is generated in operation S210, the linear RGB value may be gamma adjusted again and output in operation S250.

While specific operations of the apparatus 100 have been described above with reference to Equations 1 to 9, Equations 1 to 9 are only exemplary embodiments, and the operations of the apparatus 100 according to the exemplary embodiments are not limited thereto.

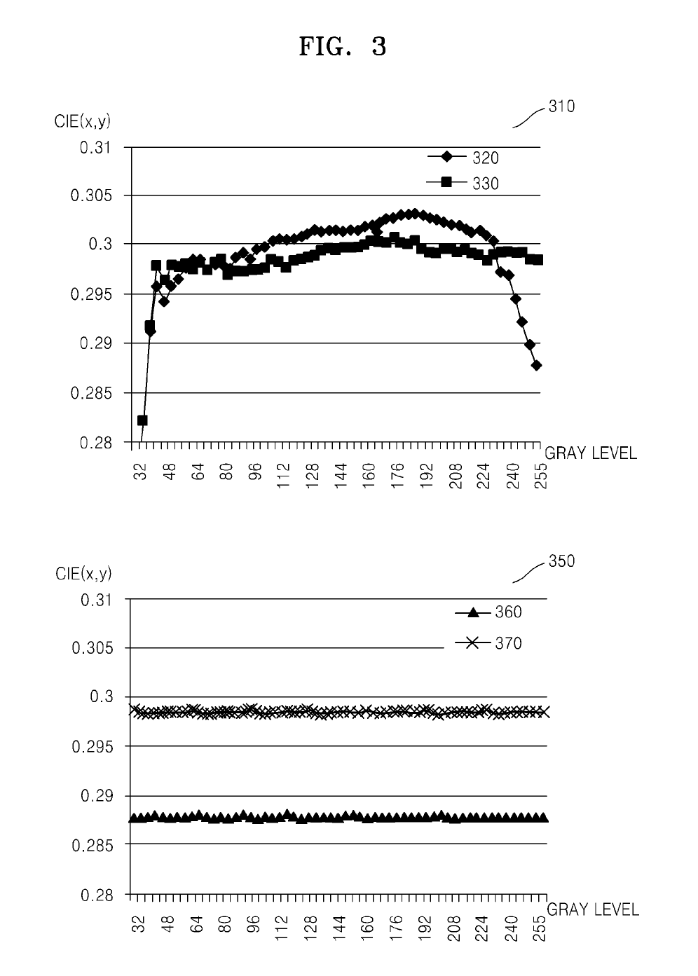

According to the exemplary embodiments, a result of the conversion of the color temperature of the gray level by using the apparatus 100 will be described in detail with reference to FIGS. 3, 4, and 5.

FIG. 3 illustrates color temperature changes according to the gray level.

A first graph 310 and a second graph 350 represent a distribution map of an X-component value 320 and a Y-component value 330, which are respectively mapped based on color temperatures according to the Commission Internationale de l'Eclairage (CIE) standards, before and after adjusting the color temperature of the gray level. A CIE-(x, y) value may be estimated according to a spectro-radiometer.

As illustrated in the first graph 310, before adjusting the color temperature of the gray level, the X-component value 320 and the Y-component value 330 are not uniformly distributed.

According to the present exemplary embodiment, the apparatus 100 may adjust the color temperature of the gray level such that, as illustrated in the second graph 350, the X-component value 360 and the Y-component value 370 may have uniformly distributed values, even if the gray levels change. Therefore, color temperature variation may almost be visually unrecognizable in the gray levels.

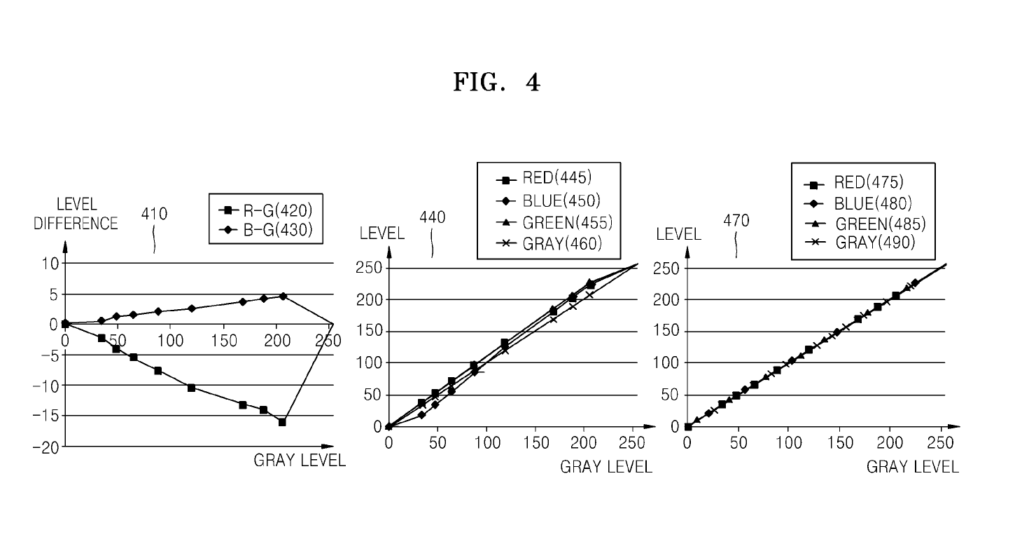

FIG. 4 illustrates RGB gamma curves generated by adjusting color variation.

In general, the R-component, G-component, and B-component of the gray level are identical. However, if the color variation between the gray level components is adjusted, an adjusted value of the R-component relative to the G-component 420, and an adjusted value of the B-component relative to the G-component 430 may vary, as illustrated in graph 410.

Graph 440 illustrates a result of adjusting the color variation without regard to the color temperature, as in the graph 410. According to the graph 440, relative to the R-component, G-component, and B-component of a gray level 460, a pure red component 445, a pure blue component 450, and a pure green component 455 may all change.

However, if the apparatus 100 according to the exemplary embodiment is used, even if the red component and the blue component are added and subtracted to adjust the color variation between the gray level values, the color temperature may be uniformly maintained, as illustrated in graph 470. Therefore, a pure red component 475, a pure blue component 480, and a pure green component 485 may not change at all, and thus may maintain the same state as red, blue, and green components of a gray scale 490.

Therefore, when adjusting the color variation without regard to the color temperature, the pure red, pure blue, and pure green components change. However, when adjusting the color variation using the apparatus 100 according to the exemplary embodiment, only the color variation in the gray region is adjusted, and the pure red, pure blue and pure green components may not be changed.

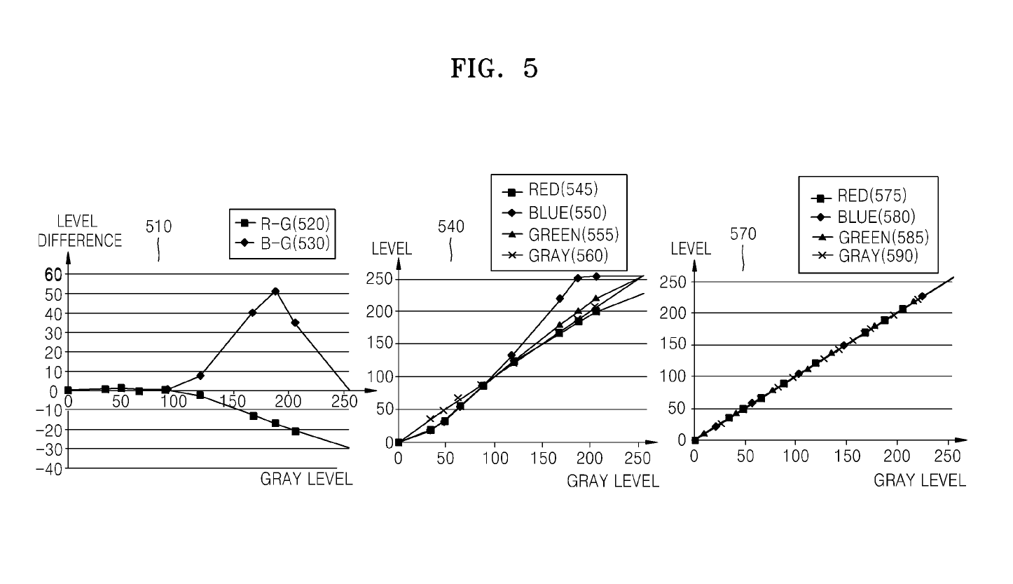

FIG. 5 illustrates RGB gamma curves generated by changing the color temperature of the gray level.

Graph 510 illustrates a difference value of a red component relative to a green component 520 and a difference value of a blue component relative to the green component 530 for each gray level, when the color temperature of the gray level is changed from a 6500K mode to a 16000K mode.

According to the graph 510, for each gray level, if the difference value of the red component 520 and the difference value of the blue component 530 are respectively applied to the red component and blue component, the color temperature variation of the gray level may be constant.

However, in comparison to gray gamma curve 560 illustrated in graph 540, if the color temperature is changed without regard to the color components composing the gray level, then a red gamma curve 545, a blue gamma curve 550, and a green gamma curve 555 may all change.

According to the present exemplary embodiment, if only the color temperature of the gray region is changed using the apparatus 100 for converting gray level, the red, blue, and green gamma curves 545, 550, and 555 may not change and may maintain the same state as a gray gamma curve 590.

Therefore, according to the present exemplary embodiment, even when using the apparatus 100 to change the color of the gray region of an actual image, skin or clothing colors of a figure may maintain their original colors and saturation loss may be prevented.

Therefore, according to the present exemplary embodiment, the apparatus 100 for converting gray level may preset a size of the gray region in an input image which is affected by the color temperature change. Also, the RGB value of the selected gray region may be converted into the user-defined target RGB value.

Accordingly, even if the RGB values for each gray level are adjusted, since the color temperature is uniformly distributed in each gray level, the color variation between the gray levels may be reduced, and thus, the color components may be accurately displayed. In addition, the highly saturated color may maintain the original color, and only the color temperature of the gray level may be changed. Therefore, technologies for differentiating picture quality such as a white balance process may be implemented.

In addition, other exemplary embodiments may also be implemented through computer readable code/instructions in/on a medium, e.g., a computer readable medium, to control at least one processing element to implement any of the above described embodiments. The medium may correspond to any medium/media permitting the storage and/or transmission of the computer readable code. The computer readable code may be recorded/transferred on a medium in a variety of ways, with examples of the medium including recording media, such as magnetic storage media (e.g., ROM, floppy disks, hard disks, etc.) and optical recording media (e.g., CD-ROMs, or DVDs).

While the exemplary embodiments has been particularly shown and described, it will be understood by those of ordinary skill in the art that various changes in form and details may be made therein without departing from the spirit and scope of the inventive concept as defined by the following claims.

What is claimed is:

1. A method of converting a gray level of a color image, the method comprising:
determining an intermediate RGB value which corresponds to an input RGB value of the color image, based on color mapping information in which target RGB values, mapped to the gray levels of the color image, are preset;
determining whether the input RGB value is included in a gray region or a color region, based on a gray variation of the input RGB value; and
if the input RGB value is determined to be included in the gray region, converting the input RGB value by using the intermediate RGB value.

2. The method of claim 1, wherein the converting of the input RGB value determined to be included in the gray region by using the intermediate RGB value comprises outputting the determined intermediate RGB value for a first input RGB value determined to be included in the gray region.

3. The method of claim 2, further comprising, if a second input RGB value is determined to be included in the color region, outputting the second input RGB value without changing the second input RGB value.

4. The method of claim 2, further comprising adjusting the intermediate RGB value to be inversely proportional to a gray variation of a second input RGB value, and outputting an added value of the adjusted intermediate RGB value and the second input RGB value, for the second input RGB value determined to be included in the color region.

5. The method of claim 1, wherein the converting of the input RGB value determined to be included in the gray region by using the intermediate RGB value comprises outputting an arbitrary RGB value which is different from the intermediate RGB value for a first input RGB value determined to be included in the gray region.

6. The method of claim 1, wherein the determining of the intermediate RGB value which corresponds to the input RGB value of the color image comprises:
determining an input gray level which corresponds to the input RGB value; and
determining the intermediate RGB value that is mapped to the input gray level, by using a look-up table in which target RGB values, mapped to the gray levels of the color image, are preset.

7. The method of claim 6, wherein the determining of the intermediate RGB value that is mapped to the input gray level from among gray levels of the look-up table comprises:
detecting a first gray level that is the same or less than the input grey level and detecting a second gray level that is the same or higher than the input gray level, and that neighbor the input gray level, from among the gray levels of the look-up table;
determining a first target RGB value which corresponds to the first gray level, and a second target RGB value which corresponds to the second gray level; and
interpolating the detected first and second RGB values to determine the intermediate RGB value.

8. The method of claim 1, wherein the determining of whether the input RGB value is included in a gray region or a color region comprises:
determining an YCrCb value which corresponds to the input RGB value;
determining a saturation level of the input RGB value by using the determined YCrCb value; and
determining the gray variation of the input RGB value by using the determined saturation level.

9. The method of claim 1, wherein the determining of whether the input RGB value is included in a gray region or a color region comprises:
determining an R-G difference value between an R-value and a G-value, an R-B difference value between the R-value and a B-value, and a G-B difference value between the G-value and the B-value; and
determining the gray variation of the input RGB value by using the determined R-G difference value, R-B difference value, and G-B difference value.

10. The method of claim 1, wherein the determining of the intermediate RGB value which corresponds to the input RGB value comprises determining the input RGB value by performing reverse gamma-correction on the RGB value of the color image,
wherein the converting of the input RGB value determined to be included in the gray region by using the intermediate RGB value comprises performing gamma-correction on the converted input RGB value.

11. An apparatus for converting a gray level, the apparatus comprising:
a gray region determiner configured to determine an intermediate RGB value which corresponds to an input RGB value of the color image, based on color mapping information including preset target RGB values that are mapped to the gray levels of the color image, and determine whether the input RGB value is included in a gray region or a color region, based on a gray variation of the input RGB value; and
a converter configured to, if the input RGB value is determined to be included in the gray region, convert the input RGB value, by using the intermediate RGB value, and determine an output RGB value of the input RGB value.

12. The apparatus of claim 11, wherein the converter is configured to output the determined intermediate RGB value for a first input RGB value determined to be included in the gray region.

13. The apparatus of claim 12, wherein, if a second input RGB value is determined to be included in the color region, the converter is configured to output the second input RGB value without changing the second input RGB value.

14. The apparatus of claim 12, wherein the converter is configured to adjust the intermediate RGB value to be inversely proportional to a gray variation of a second input RGB value, and output an added value of the adjusted intermediate RGB value and the second input RGB value, for the second input RGB value determined to be included in the color region.

15. A non-transitory computer readable recording medium having recorded thereon a program, which when executed by a computer, performs the method of claim 1.

16. A method of adjusting a grey level of a color image comprising:
determining an intermediate RGB value which corresponds to an input RGB value of the color image;
determining if the input RGB value is distributed in a grey region or in a color region of the color image;
if it is determined that the input RGB value is distributed in the grey region, converting the input RGB value using the intermediate value and outputting the converted input RGB value; and
if it is determined that the input RGB value is distributed in the color region, outputting the input RGB value.

17. The method of claim 16, wherein the determining the intermediate RGB value comprises:
determining an input gray level corresponding to the input RGB value; and
determining, using a look-up table, the intermediate RGB value that is mapped to the input gray level.

18. The method of claim 17, wherein the look-up table comprises a plurality of target RGB values mapped to a plurality of gray levels of the color image,
wherein the determining the intermediate RGB value comprises:
if the input grey level corresponds to one of the plurality of grey levels of the look-up table, determining the intermediate RGB value as the target RGB value corresponding to the one of the plurality of gray levels of the look-up table; and
if the input grey level does not correspond to one of the plurality of grey levels of the color image, detecting at least two grey levels of the plurality of grey levels of the look-up table which neighbor the input grey level, interpolating the target RGB values corresponding to the at least two of the grey levels, and determining the result of the interpolating as the intermediate RGB value.

19. The method of claim 16, wherein the determining if the input RGB value is distributed in the grey region or in the color region of the color image comprises:
determining an YCrCb value which corresponds to the input RGB value;
determining a saturation level of the input RGB value by using the determined YCrCb value; and
determining the gray variation of the input RGB value by using the determined saturation level.

20. The method of claim 16, wherein the determining if the input RGB value is distributed in the grey region or in the color region of the color image comprises:
determining an R-G difference value between an R-value and a G-value, an R-B difference value between the R-value and a B-value, and a G-B difference value between the G-value and the B-value; and
determining the gray variation of the input RGB value by using the determined R-G difference value, R-B difference value, and G-B difference value.
